(19) United States
(12) Patent Application Publication
(10) Pub. No.: US 2013/0248501 A1
(43) Pub. Date: Sep. 26, 2013

(54) ROTATING LASER WIRE STRIPPING SYSTEM

(71) Applicant: CONTROL LASER CORPORATION, Orlando, FL (US)

(72) Inventor: Gregory B. Anderson, Orlando, FL (US)

(73) Assignee: Control Laser Corporation, Orlando, FL (US)

(21) Appl. No.: 13/829,404

(22) Filed: Mar. 14, 2013

Related U.S. Application Data
(60) Provisional application No. 61/613,565, filed on Mar. 21, 2012.

(51) Int. Cl. B23K 26/36

(52) U.S. Cl. CPC B23K 26/36
USPC 219/121.69; 219/121.68

(57) ABSTRACT

A laser wire stripping apparatus having a collet having a passageway for receiving a wire therein along an axis of insertion. The collet being fixed in position relative to the axis of insertion. A laser source for producing a laser beam. An optical assembly, the optical assembly moving relative to the collet and the axis of insertion for directing a laser beam along an axis of insertion of said wire.

### CROSS REFERENCE TO RELATED APPLICATION

This application claims priority to Provisional Patent Application No. 61/613,565 filed Mar. 21, 2012, and is incorporated herein as set forth in its entirety.

### BACKGROUND OF THE INVENTION

This invention is directed to a laser wire stripping system, and more particularly, a system which utilizes a rotating laser head to strip wires located across a large area.

A rotating laser wire stripping system removes insulation from wires, multi-conductor cables, or shielded cable by using the laser power to melt or ablate the insulation so that it can be pulled or peeled from the wire or cable. As is known in the prior art, a laser system has a single wire channel assembly which provides a pathway for allowing a laser light from a source to travel through the channel assembly to a cylindrical cavity in the channel assembly. A collet is provided as a passageway for insertion of a wire into the cavity. The collet has an opening, which when the wire is properly inserted into the cylindrical cavity, is in alignment with the pathway allowing the laser light to travel to the wire in order to remove insulation from the wire. A housing assembly holds the channel assembly and allows the channel assembly to rotate within the housing assembly about the wire.

As is known from U.S. Pat. No. 6,603,094 by way of example, a laser of appropriate wavelength such as a CO₂ laser may be used as the light source for stripping insulation. As the channel assembly rotates about the end of the wire, the laser beam traces a path about the wire and melts lengths of insulation from the wire. Because the laser emits a light beam of about 10640 nm, the metallic core reflects the light and is unaffected by the laser beam as the laser melts the insulation. If the assembly is held stationary, a line may be drawn along the insulation to allow for peeling and stripping in that manner.

These prior art laser wire stripper assemblies have been satisfactory for stripping a wire one at a time as it is inserted into the housing assembly. However, the prior art system suffers from several deficiencies. First, the housing assembly is bulky. The housing assembly contains the laser source as well as the rotating channel assembly.

A one sized hole is formed in the collet which must be very close to the size of the wire or the wire will droop out of the focus of the laser beam. Furthermore, the hole into which the wire is inserted has to be close to the actual size of the wire to be operated upon and the hole size for each collet is fixed. As a result, the wire will tend to catch on the hole and the collet as the assembly spins around it at a high speed. If the wire is a multiconductor cable with a non-round shape, it is even more prone to this catching. This can tend to twist the wire while it is lasing to cause an uneven or unusable cut on the insulation. Where the collet is interchangeable, a different sized collet must be switched in to accommodate each different sized wire; requiring a “library” of collets and slowing the stripping procedure.

The prior art also suffers from the deficiency that there is no method with which to set the depth of the wire and therefore the depth of the stripped length. This is currently done by adjusting the length of the hole in the collet, but this is extremely unwieldy in a practical sense; again requiring a myriad of collets to achieve a reasonable variation of strip lengths. Additionally, there is nothing to hold the wire in place while it is being stripped, forcing the operator to hold the wire until the process is completed. This introduces human error and fatigue into the operation.

Furthermore, because of the heat and the burning during the process, debris and smoke are created. The prior art accounts for the smoke and debris by creating an airtight chamber for an air purged ventilation system to protect the objects and a vacuum for removing debris. As a result, the device becomes complicated requiring manufacturing parts to a high tolerance and an extremely difficult assembly. Additionally, because of the rotating assembly structure, it is difficult to mount a sensor to detect that the wire has been inserted and remained inserted during the entire process and therefore, without such a sensor, the system, may not be able to qualify as a Center for Device and Radiological Health (CDRH) Class 1 safe system.

Because the assembly contains the laser and the rotating channel assembly, the prior art systems take up work space, which is often scarce, at the wire stripping site. This adds to the expense and inefficiency of the worksite as two or more wire strippers could be placed in the footprint that the current prior art laser wire stripper requires. Secondly, because of the bulkiness of the housing assembly and the arrangement of the laser source, support structure and rotating head within a single housing assembly, the laser wire stripping system is immobile. This requires the wires to be brought to the wire stripper and inserted one at a time. This system is inapplicable to a large manufacturing facility where wire stripping often occurs in situ for wires on a large typical wire harness. And again if the wires in a harness are not uniform, the prior art requires switching out of the collet to accommodate multiple wire gauges within a single harness.

By way of example reference is made to FIG. 1 where a large sophisticated wiring harness 10, such as those utilized in the aircraft industry is provided. Because of the millions of wires required in sophisticated aircraft and spacecraft, it is practically impossible to wire the craft by hand in the craft itself. To accommodate such sophisticated and complex wiring needs, thousands of wires 12 corresponding to tens of thousands of feet of wiring are provided on a harness 10. The harness 10 is placed into an aircraft for interconnection with related circuitry including other panels within the aircraft. In order to protect wires 12, the wires 12 are placed into the harness 10 with full protected insulation thereon. The ends of individual wires 14 are then stripped within harness 10 to provide maximum protection of the wire throughout the assembly process. Because of the high sensitivity of certain applications such as the use of harnessed wires in airplanes, helicopters, spacecraft, missiles and the like, a slight nick to an individual wire 14 can affect operation of the entire system. For this reason, laser stripping is preferred over any mechanical method, but it is impractical because of the wire harness environment which requires mobility of the stripping system to reach each individual wire 14 within harness 10.

Accordingly, a system which overcomes the shortcomings of the prior art is desired.

### BRIEF SUMMARY OF THE INVENTION

A laser stripping system has a laser source for emitting a laser beam. A wire stripping assembly for receiving a wire therein and directing the laser energy towards the wire when the wire is disposed within the wire stripping assembly is optically connected to the laser source by an optical conduit; light tube, or fiber optic. The wire stripping assembly is freely moveable relative to the laser source.

In a preferred embodiment, the optical conduit is an optical fiber or light tube. The laser source is disposed away from the wire stripping head, and in a preferred embodiment, the laser source is capable of movement in at least two directions along a plane. Furthermore, the wire stripping head may selectively direct the laser beam along a path which circumnavigates the wire.

In yet another preferred embodiment of the invention, the wire stripping assembly includes a fixed collet, an offset assembly includes a lens assembly for receiving the laser light and directing the laser light in a substantially perpendicular direction relative to an insertion axis of the wire. The offset assembly is rotatably mounted relative to the collet to rotate 360 degrees about the axis of insertion of the wire. The wire stripping assembly has an opening, a drive roller and an idler wheel are disposed at the opening to receive the wire. The idler wheel may be biased towards the drive wheel and movable between a first position adjacent the drive wheel and a second position away from the drive wheel to accommodate different gauges of wire. A clamp may be disposed within the assembly for holding the wire during the stripping process. A sensor is disposed within the assembly for detecting the presence of a wire within the assembly.

### BRIEF DESCRIPTION OF THE DRAWINGS

Other objects, features and advantages of the present invention will be apparent from the written description and the drawings in which:

FIG. 1 is a top plan view of a wire assembly disposed within a harness in accordance with the prior art;

FIG. 2 is a block diagram of a wire stripping system constructed in accordance with the invention;

FIGS. 3 and 4 are views of a wire stripping head constructed in accordance with the invention;

FIG. 5 is a schematic diagram of a wire stripping assembly having a rotatable offset optical assembly constructed in accordance with the invention;

FIG. 6 is a schematic diagram of a self-centering linkage for a wire stripping assembly constructed in accordance with the invention for enabling the operation on a variety of wire gauges;

FIG. 7 is a schematic diagram of an adjustable depth gauge for a wire stripping assembly constructed in accordance with the invention;

FIGS. 8a and 8b are a schematic diagram of a clamp and clamping process within a wire stripping assembly in accordance with the invention;

FIGS. 9a and 9b are schematic diagrams showing a support for a wire to be stripped within a wire stripping assembly, constructed in accordance with the invention; and

FIG. 10 is a schematic diagram of a sensor disposed within a wire stripping assembly in accordance with the invention.

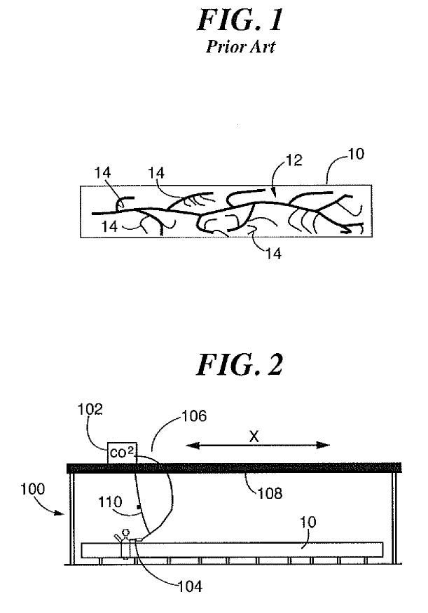

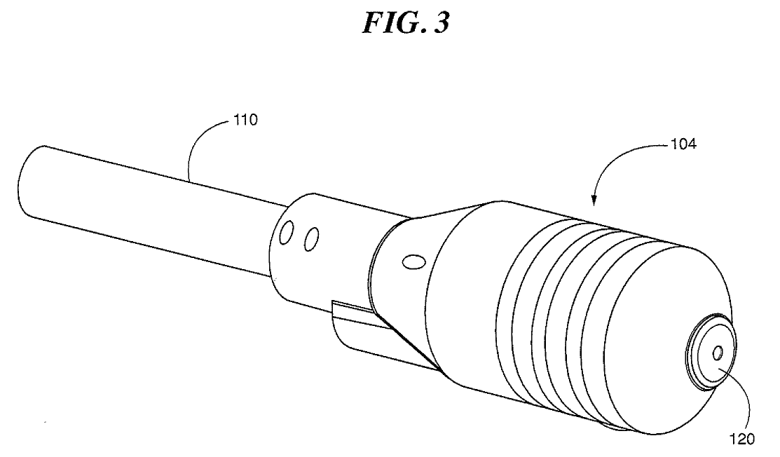

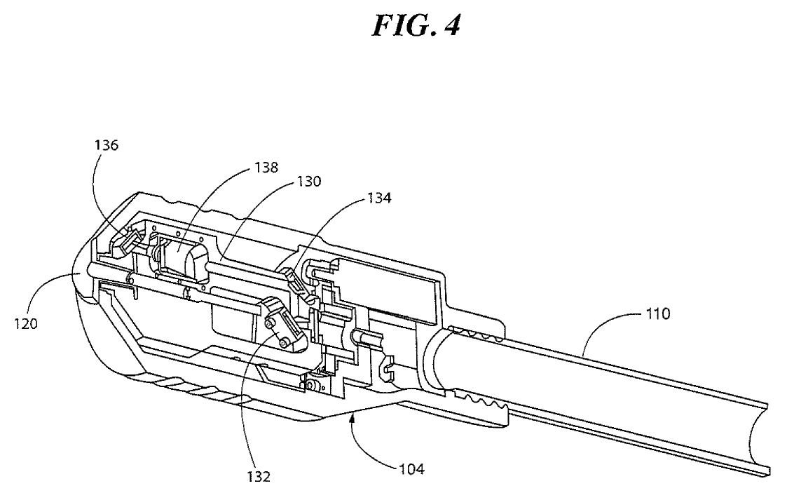

### DETAILED DESCRIPTION OF THE INVENTION

Reference is made to FIG. 2, in which a system constructed in accordance with the invention and generally indicated as 100 is shown. A laser source 102 includes a laser and the associated electronics as known in the art for creating a laser beam. In a preferred embodiment, laser source 102 is a CO₂ laser source as known in the art, outputting a laser beam of about 10640 nm. A hand held stripping assembly 104 is separate from the housing of laser source 102 and is optically connected to laser source 102 by an optical conduit 106 capable of transmitting the laser beam produced by laser source 102 to hand held wire stripping assembly 104. Optical conduit 106 may be a light pipe, but in a preferred non limiting embodiment, optical conduit 106 is an optical fiber such as an AgCl:AgBr fiber manufactured by CeramOptec.

Hand held stripping assembly 104 is capable of free movement, i.e. movement in at least two directions relative to laser source 102. Hand held wire stripping assembly 104 may be a rotating stripping assembly. In one exemplary, but non limiting embodiment, optical conduit 106 provides a laser beam input to wire stripping assembly 104. Wire stripping assembly 104 has an insertion axis A along which a wire may be inserted into wire stripping assembly 104 for stripping. Wire stripping assembly 104 includes at least one mirror which in a one mirror embodiment is disposed at a 45 degree angle to the path of the laser beam as input from fiber conduit 106. This angled mirror reflects, or directs the laser beam substantially 90 degrees relative to the insertion axis A (corresponding substantially to the orientation of the wire within wire stripping assembly 104). The mirror may rotate about insertion axis A keeping laser beam within the wire stripping assembly 104 at a constant substantially 90 degree orientation relative to insertion axis A throughout 360 degrees or more rotation about the wire.

As a result, the laser beam circumnavigates a wire disposed along axis A to melt a circular line of insulation to facilitate removal. In another less preferred embodiment, the mirror may be fixed and movement of the wire stripping assembly 104 relative to a wire disposed therein will cause removal of a line of material along the wire as a result of relative movement of the wire and the mirror. In other words, the hand held device could be rotated about the wire manually or moved along the wire to provide a stripped line to allow peeling back of the insulation. Conversely, the wire may be moved in order to effect stripping.

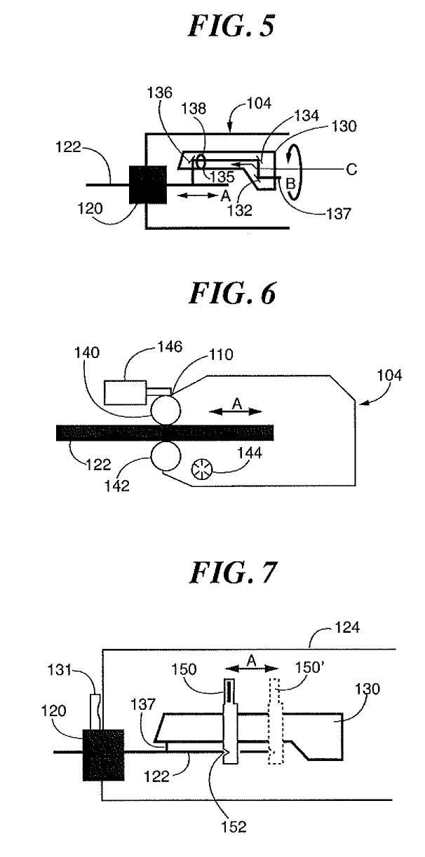

Reference is now made to FIG. 5 in which a schematic diagram of the rotation assembly for facilitating the beam of light traveling about the wire is provided. Wire stripping assembly 104 includes a collet 120 for selectively holding a wire 122 therein allowing the wire to move into and out of wire stripping assembly 104 in the directions of double-headed arrow A.

Wire 122 lies along the axis of insertion and moves in the direction of arrow A substantially along the insertion axis. A rotating optical assembly 130 is disposed within assembly 104 and rotates about insertion axis A in the direction of arrow B. Rotating optical assembly 130 includes one or more mirrors for changing the direction of an incoming beam of laser light 137 output from a laser source such as laser source 102 transmitting to the wire stripping assembly 104 as described above.

At least one mirror is disposed within rotating optical assembly 130 to change the path and direction of the incoming laser beam 137 as it enters optical assembly 130; even as optical assembly 130 is rotating. In this non-limiting embodiment, a first mirror 132 disposed at substantially a 45 degree angle relative to the axis of the incoming beam 137 receives the incoming laser beam 137 as it enters rotating assembly 130. A second mirror 134 is disposed within rotating optical assembly 130 at an angle substantially 45 degrees relative to the travel path of laser beam 137 as it leaves first mirror 132. In this non-limiting embodiment, a third mirror 136 is disposed within rotating assembly 130 downstream along the laser beam path from mirror 134 and is at a substantially 45 degree angle and directs the path of the laser beam 137 through an optical opening within rotatable assembly 130 to impinge axis of insertion A at an angle substantially perpendicular to the axis of insertion.

In a preferred, non-limiting embodiment, a focusing lens 138 may be disposed along the path traced by laser beam 137. A three mirror embodiment is shown by way of example, but any number of mirrors which can deflect the laser beam towards the insertion access at an angle sufficient to perform ablation may be used.

Collet 120 is fixed relative to insertion axis A and optical assembly 130. Optical assembly 130 may be supported on a rotating arm spindle or other type of linkage which rotates the optical assembly about axis of insertion A. In this way, wire 122 is held by a stationary collet 120 as the assembly producing the laser light rotates relative to the insertion axis. Furthermore, collet 120 can be better sized to have the right size opening to corresponding to the wire, as collet 120 no longer needs to spin around wire 122 or travel the distance of the laser beam travel. Therefore, collet 120 can be designed for greater tolerances.

As wire 122 is stripped by wire stripping assembly 104, the prior art suffered from the deficiency that the collet could only accommodate a single gauge wire. While maintaining collet 120 stationary has provided more tolerance to different gauges of wire, collet 120 is still incapable of determining the depth to which the wire is currently inserted or even provide a better guide to wires of different gauges. Reference is now made to FIG. 6 in which an embodiment of wire stripping assembly 104 having a self-centering and depth measuring assembly is shown.

A first wheel 140 and a second wheel 142 are provided at an insertion opening 110 of wire stripping assembly 104. First wheel 140 is fixed in place, while second wheel 142 is moveable between a first position adjacent, or in contact with, wheel 140 and a second position away from wheel 140. Wheel 142 is biased towards wheel 140. In this way, as a wire 122 is inserted along insertion axis A, it forces wheel 142 away from wheel 140 as it moves between wheels 140, 142. Because wheel 140 is biased, the wheels center (maintain wire 122 at a predetermined position relative to the opening), as it travels along insertion axis A. Wire 122 is in in effect pinned between the wheels.

In a preferred embodiment, a counter 144, such as an encoder, a motion sensor, or the like determines the amount of rotation of wheel 142. Knowing the rotation of wheel 142, counter 144, or a computer processor associated therewith, can determine in real time the depth to which wire 122 is inserted within housing 104. This results from the fact that a distance of rotation of wheel 142 corresponds to a length of wire 122 traversed.

In yet another embodiment of the invention, a motor 146 may be operatively coupled to drive wheel 140. In this way, wires may be ablated to a precise predetermined distance as determined by the amount of rotation of wheel 140 or 142 drawing wire 122 into laser assembly housing 104. Motor 146 is a two directional motor so that rotation in a first direction inserts the wire into wire stripping assembly 104, and rotation in the opposite direction smoothly extracts wire 122 from wire stripping assembly 104 to control the fed rate for the slitting process. This eliminates differences between individual operators to provide consistency provided in the appropriate beam exposure time along wire 122 during the slitting process.

It should be noted, that wheels 140, 142 may replace the function of collet 120, but may also be used in tandem with collet 120 positioned either upstream or downstream of collet 120 and still utilizing collet 120 as an additional support while allowing for the functionality described above of wheels 140, 142.

In an embodiment with collet 120, an alternative depth gauge may be used. Reference is now made to FIG. 7 in which a mechanical depth gauge 150 having another structure to provide wire depth measuring is provided. An adjustable depth gauge 150 is slideably mounted within wire stripping assembly 140. In a preferred embodiment, depth gauge 150 may be mounted on optical assembly 130. Depth gauge 150 is slideably disposed along insertion axis A; capable of moving between a first position proximate collet 120 to a second position away from collet 120 relative to the first position. Depth gauge 150 may be positioned to the desired stripping depth substantially at any position along optical assembly 130. As shown in FIG. 7 it is moveable between a first shorter stripping length represented as the solid adjustable gauge 150 to any position up to an including substantially the position shown in phantom as 150′ or beyond. A range finding detector, by way of example, a range finding sensor 131 detects the relative distance between range finding sensor 131 and adjustable depth gauge 150. By way of example, range finding sensor may be an optical sensor, ultrasonic sensor, radio frequency detector or the like. The change In position of depth gauge 150 along the slide path is converted into a wire depth, as known in the art. In this way, the depth of insertion of wire 122, critical for determining the length of ablation, is determined even in the absence of the wheel assembly discussed above.

During operation, the wire is inserted until it contacts adjustable gauge 150. In this way, because the sensor and the depth gauge have determined the distance between the collet and the depth gauge, the insertion length of wire 122 is known. Furthermore, in a preferred non-limiting embodiment, adjustable gauge 150 has a conically shaped receiving portion 152 for receiving the leading end of wire 122 and acts as a stop. Because of the conical shape of the receiving portion 152, as adjustable depth gauge rotates with optical assembly 130, adjustable depth gauge 150 centers wire 122 while maintaining it in position, without causing the wire to twist as a result of the rotation.

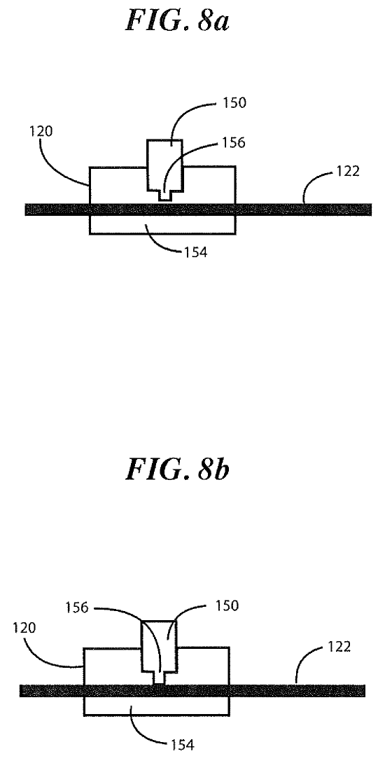

Movement of wire 122 during ablation and inaccurate positioning in the first instance, is a shortcoming of the prior art. Because collet 120 is stationary, and it is the optical assembly which rotates relative to the rest of the wire stripping assembly, it is possible to clamp wire 122 in place in the present invention. Reference is now made to FIGS. 8a, 8b, in which a clamp for maintaining wire 122 in place is provided.

A clamp 150 is disposed within stripping assembly 104 along insertion axis A. Clamp 150 is preferably mounted within fixed collet 120 and includes an anvil portion 154 having an area sufficient to support a wire 122 thereon. Clamp 150 includes a pinching mechanism 156 capable of moving or extending towards insertion axis A a sufficient distance to press wire 122 against collet 120 is provided at a position within stripping assembly 104 at an opposed position relative to anvil portion 154 within collet 120 and across insertion axis A. In a preferred, but non-limiting embodiment, pinching mechanism 156 includes an extendable rod which moves from a first position away from anvil 156 to a second position towards anvil 154. It should also be noted, noted, that any mechanical system capable of trapping, pinning, pushing or pressing, wire 122 within collet 120 may be utilized as pinching mechanism 156.

During operation, wire 122 is inserted along insertion axis A a predetermined distance as determined by the depth gauge as discussed above. Once travel has stopped, pinching assembly 154 clamps wire 122 to anvil 156 to maintain wire 122 in position during the ablation process.

During ablation, the rotatable optical assembly 130 moves along insertion axis A to ablate the coating from the wire. As rotational optical assembly 130 moves along insertion axis A, it may either rotate around axis B to ablate the entire wire or not rotate to slit the wire. It should be noted, that in other embodiments, where clamping is not required, optical assembly 130 may operate as the wire is inserted along insertion axis A.

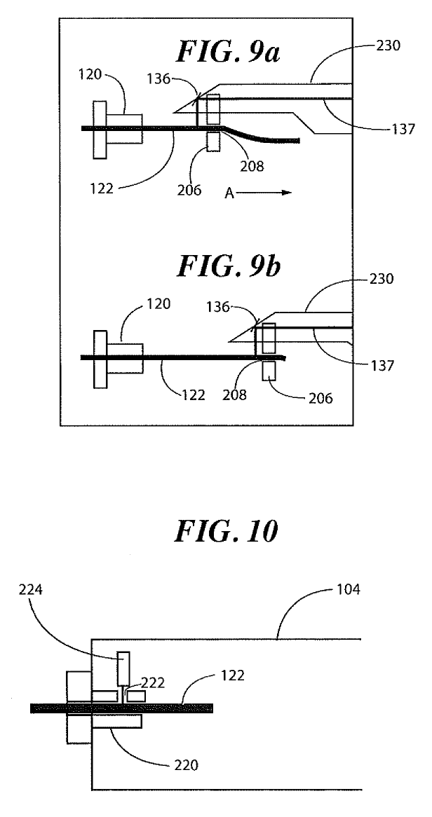

Many times, a wire to be stripped is not straight because of bending or drooping and therefore, the wire avoids the focal point of the laser beam as the laser beam moves about and along insertion axis A, or when in the slitting mode, traces a straight line; missing any bends in the wire. Reference is now made to FIGS. 9a and 9b wherein a structure for ablating the wire while accommodating bends in the wire 122 is provided. Stationary collet 120 supports a wire 122 within assembly 104. An optical assembly 230 directs a beam to a focal point along an insertion axis of wire 122. The operation of optical assembly 230 is the same as optical assembly 130, including the necessary mirrors and optics to direct a beam as taught above. The primary difference being the inclusion of a support 206 mounted to optical assembly 230. Support 206 includes a channel 208 therein for receiving and supporting a wire 122. Channel 208 has a radius sufficiently large so as not to twist wire 122 disposed therein while rotating.

As can be seen in FIG. 9b, during the ablation or slitting process, optical assembly moves in the direction of Arrow A relative to wire 122. This is done by the movement of optical assembly 230. Because wire 122 is supported within channel 208, channel 208 will straighten/remove-droop in wire 122 as support 206 moves in the direction of Arrow A. Support 206 is substantially adjacent the focal point of exiting laser beam 137. Substantially adjacent means for the purposes of this invention, close enough such that the support provided by support 206 to drooping wires straightens the wire sufficiently to place the wire 122 at the focal point of laser beam 137 as optical assembly 230 moves along insertion axis A as wire 122 moves relative to channel 208. Furthermore, because support 208 is disposed upstream of the laser path in the direction of Arrow A as wire 122 is straightened prior to be being ablated by laser beam 137. In this way, even a drooping wire may be slit (optical assembly 230 does not rotate during movement) or ablated (optical assembly 230 rotates during movement in the direction of Arrow A); even a crooked wire 122 is properly stripped. While the diameter of channel 208 is critical in that it must be sufficiently sized to provide support to wire 122, it is sufficiently large that rotation of support 206 about wire 122 will not twist wire 122 when disposed within channel 208.

Safety, given the presence of smoke, a hot light source and the like is an issue during the ablation process. Laser beam 137 exits optical assembly 130 at an exit point 135. Exit point 135 may be a transparent portion of assembly 130, or a physical opening. In an embodiment in which a physical opening is provided, air can be supplied through a spindle at an entry point to optical assembly 130 in the direction of Arrow C. In a preferred embodiment, it is substantially the same path as laser beam 132 through optical assembly 130 to provide a positive air pressure within optical assembly 130. The pressure is between 1 to 10 psi. As air exits the small hole forming exit 139, it enhances the processing capabilities with the cutting operation as the opening is dimensioned to be the size of a traditional cutting nozzle. Furthermore, by providing a positive pressure, the smoke and debris is prevented from entering the optical assembly 130. The optical assembly 130 is a self-contained sealed optical assembly; as a result no sealing of the other elements of the wire strip assembly is required. The optics are protected.

Because the prior art collet is spinning with the entire device, a complex sensor network is required to confirm that the wire has been inserted and remained inserted throughout the process. Reference is now made to FIG. 10 in which a structure for detecting the presence of wire 122 within stripping assembly 104 at the beginning and during the process is provided. Like numbers are utilized to indicate like structures. The primary difference being the use of a sensor at the collet. A collet 220 includes an access point 222 which provides access to wire 122 as it is inserted through the collet. A presence detector sensor 224 is disposed at access point 222 to sense the presence or absence of wire 122 within collet 220. Because collet 220 is fixed in the present invention, only a single sensor which may be formed as part of the collet or separately, is required.

During operation, the focused laser beam energy, melts, ablates or vaporizes the insulation. With the appropriate laser power and the correct number of rotations (as a function of power, laser frequency and insulation type and thickness) removal of a ring of insulation without damaging the wire, shielding or inner material can be accomplished. Additionally, if the wire is slowly separated from the wire stripping mechanism, and the wire stripping mechanism is the rotational wire stripping mechanism, the focused beam may be directed from a starting point to the end of the wire as rotation continues so that the entire insulation may be removed without the need for manual removal of any insulation. If a non-rotation mode or non-rotating wire stripping assembly is utilized, if the wire is slowly separated from the focused beam along the insertion axis A such that the focused beam is directed from a starting point to the end of the wire, then a slit from the starting point to the end of the wire may be cut in the insulation facilitating removal of the stripped insulation.

In a further preferred embodiment, laser source 102 is positioned away from the work area either above or below the work area for laser assembly 104. This frees up work space to accommodate large harnesses having many wires (scores or even hundreds) to be stripped, or several devices working side by side. In a preferred embodiment, to accommodate large work areas such as are necessary for assembly of harness 10. For example, system 100 includes a slide 108 moveable in the direction of at least arrow X to move along harness 10 to access the wires 14 of wire assembly 12 which require stripping or even mounted to a movable cart. In an even more preferred embodiment to accommodate larger work areas, such as those typically utilized in the aerospace industry, slide 108 is moveable in the X and Y directions so that laser source 102 may traverse along a plane to enable access of the wire stripping assembly 104 to substantially any spot on the work space presented by harness 10. To prevent fatigue and to prevent wire stripping assembly 104 from inadvertently falling and damaging harness 10, a so-called zero gravity arm 110 provides support for wire stripping assembly 104 from slide 108 to maintain wire stripping assembly 104 in a position at a distance above the work area, but within easy access to a user.

As will be understood that the stripping assembly in a fixed collet and a rotating optical assembly lends itself to both a table mounted embodiment and the hand-held embodiment of system 100. Furthermore, by holding the rotating optical assembly still and moving the optical assembly along insertion axis A, the wire may be slit utilizing a fixed collet. Conversely, by rotating the optical assembly utilizing the fixed collet, the outer casing of the wire may be ablated while still allowing for a simpler sensor assembly, a simpler construction, and the like.

Thus, while there have been shown, described and pointed out fundamental novel features as applied to the preferred embodiment, it is understood that various omissions, substitutions and changes in the form and details of the device illustrated, and in its operation, may be made by those skilled in the art without departing from the spirit and scope of the disclosure in substantial substitution of elements are fully intended and contemplated. It is also to be understood that the drawings that are not necessarily drawn to scale but they are merely conceptual in nature.

What is claimed as new and desired to be protected by Letters Patent of the United States is:

1. A laser wire stripping system comprising:
a laser source for producing a laser beam;
a wire stripping assembly, said wire stripping assembly being moveable relative to the laser source; and
an optical conduit for optically coupling the laser source to the wire stripping assembly, said wire stripping assembly adapted to receive a wire therein along an axis, the wire stripping assembly stripping the wire with the laser beam when the wire is disposed within said wire stripping assembly.

2. The system of claim 1, wherein said wire stripping assembly includes a rotating optical assembly for directing the laser beam about the wire.

3. The system of claim 1, wherein said optical conduit is in an optical fiber.

4. The system of claim 1, further comprising a slide capable of movement in at least one direction, the laser beam source being disposed on the slide, and the wire stripping assembly not being disposed on the slide.

5. The system of claim 1, wherein said wire stripping assembly is moveable from a first work space location to a second work space location.

6. A laser wire stripping apparatus comprising:
a collet having a passageway for insertion of a wire therein, along an axis of insertion, the collet being fixed in position relative to the axis of insertion;
a laser source for producing a laser beam; and
an optical assembly, the optical assembly moving relative to the collet and the axis of insertion for directing a laser beam along the axis of insertion of said wire.

7. The laser wire stripping apparatus of claim 6, wherein the optical assembly rotates relative to the collet and about the axis of rotation.

8. The laser wire stripping apparatus of claim 6, wherein the optical assembly moves along the axis of insertion between a first position and a second position, the second position being farther from the collet than the first position.

9. The laser wire stripping apparatus of claim 6, wherein the wire stripping assembly is movable relative to the laser source, and an optical conduit for optically coupling the laser source to the wire stripping assembly.

10. The laser wire stripping apparatus of claim 6, further comprising at least a first mirror disposed within said optical assembly for changing a path of the laser beam.

11. The laser wire stripping apparatus of claim 6, wherein said optical assembly is an offset rotation assembly.

12. The laser wire stripping apparatus of claim 6, further comprising a depth measuring and centering assembly for measuring a depth to which a wire is inserted into the wire stripping assembly, and centering the wire along the insertion axis.

13. The laser wire stripping apparatus of claim 12, wherein said depth measuring and centering assembly includes a first roller and a second roller, the first roller being moveable between a first position substantially adjacent the second roller and a second position further from the second roller than the first position, the first roller being biased in a direction towards the first roller, the first roller being moved from the first position towards the second position when a wire is inserted between the first roller and second roller.

14. The laser wire stripping apparatus of claim 13, further comprising a motor operatively coupled to the second roller for rotating the second roller.

15. The laser wire stripping apparatus of claim 13, further comprising a rotation measuring sensor for monitoring rotation of the first roller and determining an amount of rotation performed by the first roller.

16. The laser wire stripping apparatus of claim 6, further comprising adjustable depth gauge being mounted on the optical assembly downstream of the collet for engaging the wire as the wire is inserted into the wire stripping assembly, the adjustable depth gauge being moveable between a first position and a second position along the insertion axis, and determines the distance which the wire has been inserted into the wire stripping assembly as a function of a position of the adjustable depth gauge between the first position and second position.

17. The wire stripping assembly of claim 6, further comprising a clamp disposed along the insertion axis, the clamp clamping the wire during operation of the optical assembly.

18. The system of claim 6, further comprising a support, disposed on said optical assembly downstream of the collet, for receiving a wire therein and moving along the insertion axis with movement of the optical assembly along the insertion axis.

19. The system of claim 6, wherein the collet includes a first channel for receiving the wire therethrough, and a second channel for providing access to the first channel, and a sensor for detecting, through the second channel, the presence of the wire when the wire is disposed within the first channel.

20. The system of claim 6, further comprising a positive air supply in fluid communication with the rotatable optical assembly, and providing a positive pressure within the optical assembly.

21. A laser wire stripping apparatus comprising:
a laser source for producing a laser beam;
an optical assembly, the optical assembly moving relative to an insertion axis of a wire received within the laser wire stripping apparatus for directing a laser beam along the axis of insertion; and
a depth measuring and centering assembly, the optical assembly moving relative to the depth measuring and centering assembly, the depth measuring and centering assembly measuring a depth to which the wire is inserted along the insertion axis, and centering the wire along the insertion axis.

22. The laser wire stripping apparatus of claim 21, wherein said depth measuring and centering assembly includes a first roller and a second roller, the first roller being moveable between a first position substantially adjacent the second roller and a second position further from the second roller than the first position, the first roller being biased in a direction towards the first roller, the first roller being moved from the first position towards the second position when a wire is inserted between the first roller and second roller.

23. The laser wire stripping apparatus of claim 22, further comprising a motor operatively coupled to the second roller for rotating the second roller.

24. The laser wire stripping apparatus of claim 22, further comprising a rotation measuring sensor for monitoring rotation of the first roller and determining an amount of rotation performed by the first roller.

25. A method for stripping a wire comprising the steps of:
guiding a wire with a collet into a wire stripping assembly along an axis of insertion
producing a laser beam; and
rotating an optical assembly relative to the collet and the axis of insertion for directing a laser beam received at the optical assembly along the axis of insertion of the wire.

26. The method of claim 25, further comprising moving the wire stripping assembly relative to a laser source.

27. The method of claim 25, further comprising the step of determining a depth to which a wire is inserted into the wire stripping assembly.

28. The method of claim 27, wherein the depth is measured by the steps of:
providing a first roller and a second roller, the first roller being moveable between a first position substantially adjacent the second roller and a second position further from the second roller than the first position; and
moving the first roller from the second roller by inserting a wire to be ablated between the first roller and second roller, and measuring the rotation of the first roller to determine an amount of rotation performed by the first roller.

29. The method of claim 24, further comprising the step of measuring a depth to which a wire is inserted into the wire stripping assembly by providing a slideable depth gauge moveable between a first position and second position along the insertion axis and determining the distance which the wire has been inserted in the wire stripping assembly as a function of a position of the adjustable depth gauge.
